(19) United States
(12) Patent Application Publication
(10) Pub. No.: US 2023/0410680 A1
(43) Pub. Date: Dec. 21, 2023

(54) LUDIC-EDUCATIONAL MODULAR SYSTEM

(71) Applicant: CARTESIA SOLUTIONS S.R.L., VICOPISANO (IT)

(72) Inventors: Marco BARTALUCCI, Castelfranco di Sotto (IT); Antonio OCCHIPINTI, CASCINA (IT)

(21) Appl. No.: 18/248,131

(22) PCT Filed: Sep. 30, 2021
(86) PCT No.: PCT/IB2021/059001

§ 371 Date: Apr. 6, 2023

(30) Foreign Application Priority Data
Oct. 7, 2020 (IT) 102020000023617

(51) Int. Cl. G09B 19/00; G08C 17/02

(52) U.S. Cl. CPC G09B 19/0053; G08C 17/02

(57) ABSTRACT

Ludic-educational modular system including plurality of electronic modules each including: common portion to all the modules including, equivalent storage medium including a pre-programmed computer program, an equivalent computer connected to the storage medium to process input data and return output data based on the program, equivalent first interface connecting to each other the modules, equivalent second interface connecting the module to an external electronic device or another module and transmitting input data and output data between the module to a device or another module, a singular portion including functional apparatus connected to the computer performing a predetermined function by generating the output data based on at least one parameter settable in the computer program, and the computer allowing the manipulation, by the functional apparatus and/or device, of at least one parameter to an external user to allow only configuration of the function without modifying the program programming.

The present invention relates to a ludic-educational modular system of the type specified in the preamble of the first claim.

In particular, the present invention relates to a modular system including a plurality of modules that can be interfaced in different ways in such a way as to allow the creation of educational games, but also other functions such as, for example, typical of sectors such as the home automation, the remote controlling, the automation, the integrated systems, the communication, the robotics or more.

As is known, the growing diffusion of connected electronic systems is radically changing the way of relating to the objects that surround us; it is, in fact, more and more common to imagine an interaction with objects in an easy, intuitive, fast way. The world of games is also showing itself to be permeable to this new way of interacting. It is, in fact, relatively easy to imagine cause-effect or event-action relationships between the user and the objects surrounding him, even if the realization of this is difficult and conveyed through a more or less complex programming of the devices equipped with a microprocessor. This activity requires, not surprisingly, a certain level of experience and study.

Some such systems are described in patent applications US-A-2017373434, US-A-2012122059 and US-A-2016249478.

The aforementioned systems substantially include a plurality of modules, determined by electronic cards, which can be mutually interfaced through, for example, mechanical, electronic or magnetic means or interface means that combine said technologies.

Furthermore, the modules can connect to external devices, for example control devices, via a Wi-Fi network, or they can also provide for wiring or other. The known art described includes some important drawbacks.

In particular, all the systems of the known art require rather high knowledge, in terms of programming, since the components of the systems must be programmed one by one in order to be able to determine their functionality.

In this sense, therefore, the systems of the known art, although they can be used efficiently in many different sectors, are not well suited to recreational-educational uses in which the end user is, by definition, inexperienced and in any case certainly not prepared to be able to devote himself to a high-level programming of the modules that make up the system.

In this situation, the technical task underlying the present invention is to devise a ludic-educational modular system capable of substantially obviating at least part of the aforementioned drawbacks.

Within the scope of said technical task, it is an important object of the invention to obtain a ludic-educational modular system which is capable of reducing the complexity of management while maintaining high functional performance at the same time.

Another important object of the invention is to realize a system that includes a family of devices capable of interconnecting through existing and more widespread structures, such as Wi-Fi, Bluetooth and similar, and of interacting without the need for programming, offering the possibility to perform a series of functions, leaving the user the possibility to decide the interaction modalities in a much simpler and more intuitive way with respect to the systems of the known art.

The technical task and the specified aims are achieved by a ludic-educational modular system as claimed in the annexed claim 1.

Preferred technical solutions are highlighted in the dependent claims.

The characteristics and advantages of the invention are clarified below by the detailed description of preferred embodiments of the invention, with reference to the accompanying drawings, in which:

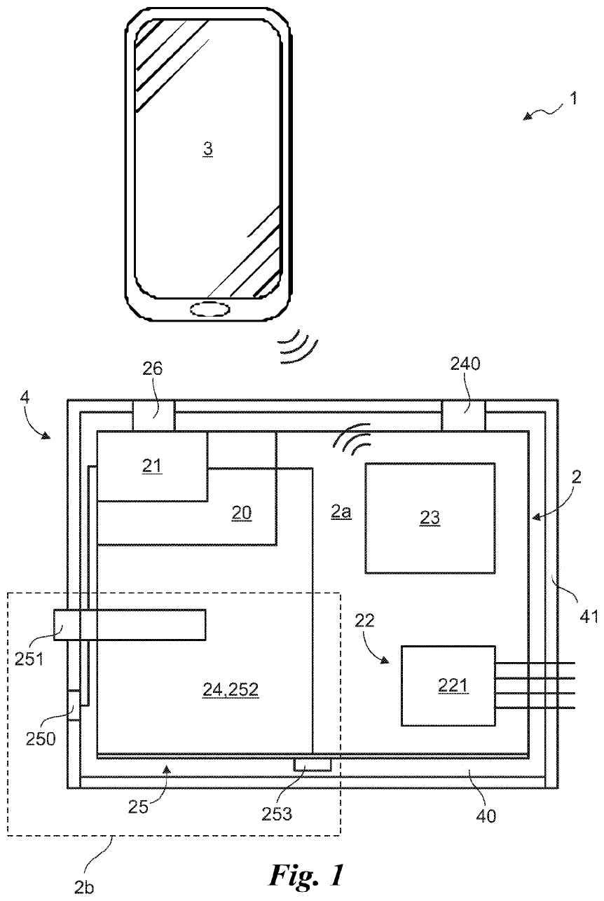

the FIG. 1 shows a simplified diagram of a ludic-educational modular system according to the invention.

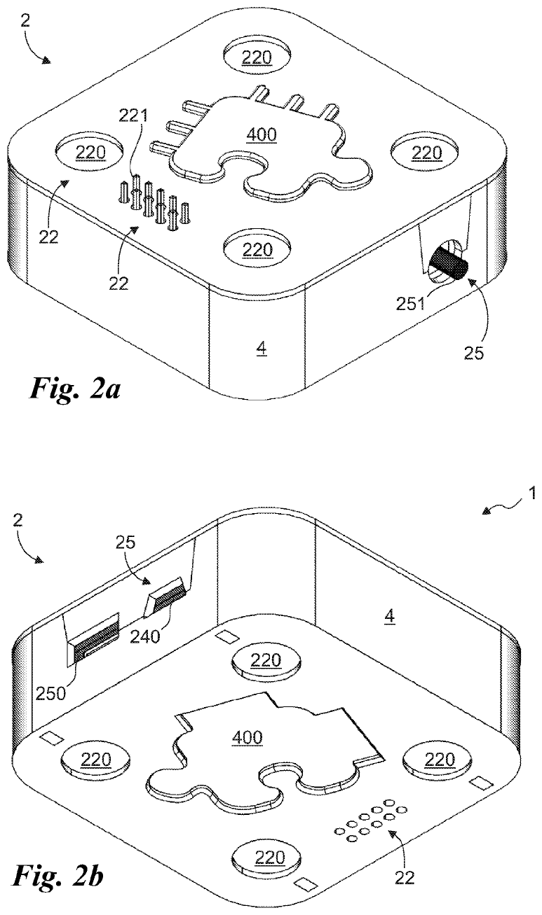

the FIG. 2a shows a top perspective view of an exemplary embodiment of a module of a ludic-educational modular system according to the invention;

the FIG. 2b is a perspective view from below of the FIG. 2a module;

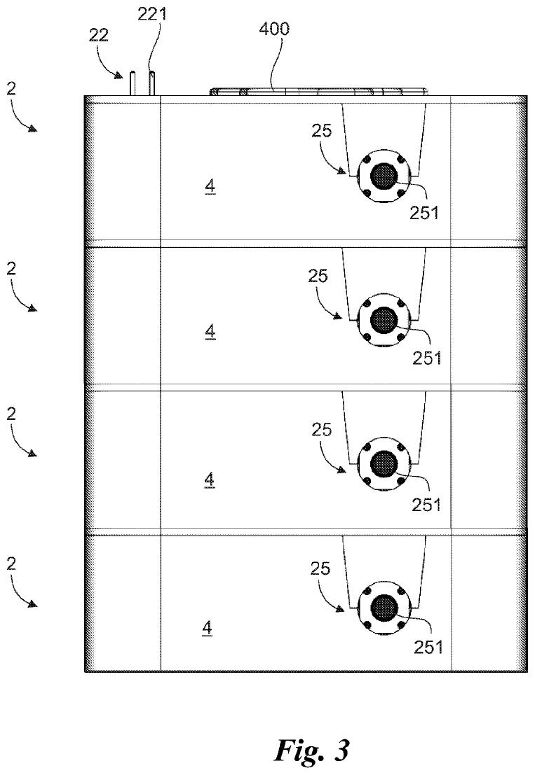

the FIG. 3 is a front view of a plurality of modules of a ludic-educational modular system according to the invention mutually coupled and stacked.

In the present document, the measurements, values, shapes and geometric references (such as perpendicularity and parallelism), when associated with words like “about” or other similar terms such as “approximately” or “substantially”, are to be considered as except for measurement errors or inaccuracies due to production and/or manufacturing errors, and, above all, except for a slight divergence from the value, measurements, shape, or geometric reference with which it is associated. For instance, these terms, if associated with a value, preferably indicate a divergence of not more than 10% of the value.

Moreover, when used, terms such as “first”, “second”, “higher”, “lower”, “main” and “secondary” do not necessarily identify an order, a priority of relationship or a relative position, but can simply be used to clearly distinguish between their different components.

Unless otherwise specified, as results in the following discussions, terms such as “treatment”, “computing”, “determination”, “calculation”, or similar, refer to the action and/or processes of a computer or similar electronic calculation device that manipulates and/or transforms data represented as physical, such as electronic quantities of registers of a computer system and/or memories in, other data similarly represented as physical quantities within computer systems, registers or other storage, transmission or information displaying devices.

The measurements and data reported in this text are to be considered, unless otherwise indicated, as performed in the International Standard Atmosphere ICAO (ISO 2533:1975).

With reference to the Figures, the ludic-educational system according to the invention is globally indicated with the number 1.

System 1 is preferably oriented to provide ludic and educational experiences. However, system 1 can also be effectively used in other areas such as, for example, remote controlling, home automation, automation, integrated systems, gaming, communication, robotics or more.

System 1 includes a plurality of modules 2.

The modules 2 are substantially electronic elements having the ability to perform one or more elementary functions of modern electronic devices and to communicate both with each other and with all compatible devices.

In general, each module 2 can send data to other modules 2 and can perform actions according to the values or states of the data received or according to the status of the module. The data is sent with events that can correspond, for example, to the achievement of certain values of signals or internal variables or with periodic events according to settable times. The values of the variables that generate the events can be generated by local sensors, by sensors located in other devices, by internal variables and even complex functions performed on internal signals or variables. Each module 2 receives event signals which contain information on the values of variables and can perform actions both on the local components and by generating and transmitting signals in turn.

Advantageously, in more detail, the modules 2 each comprise a common portion 2a and a singular portion 2b.

The common portion 2a is substantially common to all the modules 2. This means that the modules 2 define, at least in part, identical characteristics.

The singular portion 2b, on the other hand, is a part of module 2 which can be uncommon and which, therefore, can be different from module 2 to module 2.

Of course, this does not mean that duplicates of the same module 2 can be included in system 1.

As can be seen from the structure of the modules 2, they are substantially similar to a modular system such as LEGO™ in which, as is known, at least the male-female coupling areas are substantially common to all the pieces, while other parts, for example defining the geometry or extension of the piece, are different.

The common portion 2a of each module 2, in any case, preferably comprises at least one equivalent storage medium 20.

From here on, the equivalent term means that the component of module 2 performs the same main functions and can also, for example, be identical. Of course, it is not necessary, for example in the case of the storage medium 20, that the storage medium 20 be exactly identical, but it is sufficient that it be able to carry out at least the same actions described.

The storage medium 20 is substantially configured to include a plurality of data. For example, the storage medium 20 can allow the recording of data on a fixed physical memory. Furthermore, the storage medium 20 can allow the temporary recording of data on a volatile memory.

Essentially, the storage medium 20 is configured to include at least one computer program. The computer program can be any program, or software, that can be installed on the storage medium 20 to be then executed as described hereinafter. The computer program can be any firmware, or software, also upgradeable with suitable tools.

Advantageously, the computer program is pre-programmed. This means that system 1, when available to a user or an operator, is already pre-programmed and it is not necessary to modify it.

Of course, although the storage medium 20 is identical in itself, the computer program does not have to be completely identical, but can have different portions, for example dedicated to the operation of components included in the singular portion 2b of module 2.

Each module 2 it also includes an equivalent processor 21.

The computer 21 is preferably a computer of the electronic type, for example a processor, capable at least of accessing the storage medium 20 to execute the computer program.

Therefore, the processor 21 is preferably operationally connected to the storage medium 20.

The processor 21, moreover, is configured to process input data and return output data. The data, of course, is processed according to the schedule as previously described.

The input data can arrive from other modules 2 and, in the same way, the output data can be returned to the same module 2 or forwarded to another module 2. Or the modules 2 could be able to interact with an external electronic device 3.

Therefore, the incoming data could arrive from the device 3 and/or the outgoing data could be forwarded to the device 3.

The device 3 can be any electronic device at least capable of communicating with the processor 21. The device 3 can be, therefore, a device such as a PC, a smartphone, a tablet or other similar electronic devices.

Furthermore, each module 2 comprises equivalent first interface means 22.

The first interface means 22 are configured to operationally connect the modules 2. In particular, the first interface means 22 can connect a first module 2 and a second module 2, or a plurality of modules 2 simultaneously.

The first interface means 22 can therefore correspond to constraint means and can allow the physical connection, or rather the integral constraint, between the modules 2.

In this case, the first interface means 22 can include interlocking mechanisms, or resolvable coupling mechanisms known to the current state of the art, or they can comprise more advanced systems.

Preferably, the first interface means 22 comprise magnetic elements 220.

The magnetic elements 220 are adapted to mutually constrain the modules 2 by means of a magnetic force. For example, the magnetic elements 220 can include oppositely polarized magnets on the different modules 2.

In order to facilitate the realization of the constraints, each module 2 can be included in a container 4.

The container 4 is substantially adapted to contain the modules 2. Therefore, the container 4 comprises both the common portion 2a and the singular portion 2b. In particular, the container 4 preferably defines a plate shape.

With the term plate we mean two of the dimensions are preponderant with respect to the third. In this sense, preferably, the container 4 defines a card or card shape which gives particular ease of handling to the container 4 itself.

Preferably, in general, the container 4 includes at least two flat walls 40.

The flat walls 40 are preferably opposite each other. Therefore, they can correspond with the two largest faces of the card. Furthermore, the flat walls 40 are preferably surrounded and mutually connected by side walls 41.

Therefore, the container 4 preferably also includes side walls 41. Said side walls 41 can be designed to include elements preferably accessible from the outside, possibly also the first interface means 22, as subsequently explained.

Advantageously, the flat walls 40 are configured to allow the modules 2 to be stacked in a stable manner.

In this regard, the flat walls 40 could each comprise 400 matches.

The matches 400 can be protuberances, adapted to be inserted into a cavity arranged on a flat wall 40 of another module 2, and/or cavity, adapted to receive a protuberance arranged on a flat wall 40 of another module 2.

Preferably, each module 2 includes both a protuberance and a cavity arranged on opposite flat walls 40 and the modules, as a whole, include cavities and protuberances, or rather matches 400, mutually counter-shaped, for example having a particular shape such as that of a piece of a puzzle, as shown in FIGS. 2a-2b.

Furthermore, the flat walls 40 preferably comprise the first interface means 22.

In particular, the magnetic elements 220 can be included on the flat walls 40.

For example, the magnetic elements 220 can be included on the flat walls 40 in such a way as to have polarity opposite on the different flat walls 40.

Furthermore, if the flat walls 40 have a substantially rectangular shape, the magnetic elements 220 can be arranged at the vertices of the flat walls 40.

The first interface means 22 can further comprise, alternatively or together, wiring 221.

The wiring 221 are preferably electrical connections suitable for physically connecting the modules 2. The wiring 221 are substantially known in the current state of the art and are intended as both male and female. It is therefore intended that the wirings 221 include both a cable to be connected to a module 2 and a connector adapted to house part of a cable coming from another module 2.

Naturally, the wirings 221 can be of any type and can include connectors such as USB or other technologies well known in the current state of the art.

The wiring 221 can therefore be arranged on the side wall 41 of the container 4 or also on the flat walls 40.

Preferably, the wiring 221 in the upper and lower part of the container 4, on the flat walls 40, are used for the connections between modules 2, while the wiring 221 on the side walls 41 of the container 4 are used to connect any “add-ons” or extensions in general of the module 2 itself.

The first interface means 22 could also be wireless.

For example, the first interface means 22 may include wireless connectors 222.

Such wireless connectors 222 may be connectors capable of transferring information or power wirelessly. For example, the wireless connectors 222 can be Bluetooth™, infrared or even wireless power supplies adapted to power another module 2 with wireless technology as now common and known for electronic means belonging to telephony or household appliances in general.

Preferably, both the wiring 221 and the wireless connectors 222 are configured to place the modules 2 in direct communication with each other, or with any add-ons, and to transmit input and output data between the modules 2.

In summary, the first interface means 22 can include one or more chosen among the magnetic elements 220, the electrical wiring 221 and the wireless connectors 222.

Any combination thereof is part of the present invention.

Each common portion 2a also comprises equivalent second interface means 23.

The second interface means 23 are preferably configured to connect the module 3 and the external electronic device 3 to each other.

Or, the second interface means 23 can be configured to communicate with another module 2.

Preferably, the second interface means 23 is configured to transmit the input data and the output data between the module 2 and at least one device 3. Furthermore, they can be configured to transmit input data and output data to another module 2. Basically, in this second embodiment, the second interface means 23 are substantially interchangeable or coincide with the first interface means 22. Or the first interface means 22 and the second interface means 23 could, in any embodiment, be in one piece and correspond to the same device.

More in detail, the second interface means 23 preferably comprise at least one wireless device.

The wireless device is configured to put the module 2 in communication with the device 3 or with another module 2. In this second case, as previously anticipated, the wireless device can substantially coincide with the wireless connector 222 of the first interface means 22.

Each common portion 2a can also comprise equivalent power supply means 24.

The power supply means 24 are configured to power at least the processor 21. Furthermore, if necessary, according to the chosen embodiments, the power supply means 24 can be configured to also power the interface means 22, 23.

The power supply means 24 may include a battery, either fixed or removable, or may also include a power supply connector 240.

If present, the power supply connector 240 is configured to allow the electrical connection between module 2 and an external electrical network. For example, the power supply connector 240 may be of the USB type. Furthermore, it is preferably arranged on the container 4 in such a way as to be accessible from the outside. For example, the power supply connector 240 can also be arranged on the side walls 41.

Naturally, the power supply means 24 are not strictly necessary, as it can be established that a module 2 is powered by another module 2, for example through the first interface means 22, in particular the wireless connector 222. Therefore, at least some modules 2 could be devoid of power supply means 24.

The singular portion 2b, on the other hand, comprises functional means 25.

The functional means 25 are preferably configured to perform at least one predetermined function.

The term function substantially means an action originating from the input into module 2 of the input data and having as a consequence the generation of output data.

Therefore, the functional means 25 generates the output data. When generating the output data, the “function” can produce an action, which can possibly be interpreted as a “change in the module status”. A change in the status of the module can be an abstraction of the possible actions to be performed, for example moving or stopping a motor: module 2 can, for example, go from the state of “letting current flow on a pin” to the state “interrupting the current on a pin”.

Furthermore, the function is substantially established through the computer program. Even more in detail, the output data is generated on the basis of at least one parameter that can be set in the computer program.

The parameter, therefore, is substantially a variable of the computer program that can be set in such a way as to determine a specific operation of the functional means Naturally, the operation of the functional means 25 could be determined by a plurality of parameters.

The computer program, as already mentioned, is already pre-programmed and, preferably, cannot be manipulated by an external user intended as a user of the system 1.

The functional means 25 are also operationally connected to the computer 21 in such a way as to be able to communicating with it, for example forwarding input data, or receiving an input data suitable for establishing the function of the functional means 25.

Advantageously, the processor 21 is configured to allow only the manipulation of the parameter to an external user in such a way as to allow only the configuration of the function of the functional means 25 without modifying the programming of the program.

Thus, system 1 is only configurable.

The configurable only system 1 is a normal digital electronic system in which there is actually a software residing in a non-volatile memory. Differently from a programmable system, in the system the modality in which the software interacts with the user and with the electronics of the system can only be configured.

In particular, the software is primarily composed of a main component, called “basic software”. The basic software is built and preloaded on system 1 in production and cannot be modified by the user. The basic software strongly depends on the type of electronics of the system in question: a system 1 with an integrated temperature sensor and an external port for connecting a second temperature sensor can be an example. In this example, the basic software can therefore implement all that is necessary for:
board start-up: basic setting of system 1 and the peripherals used, for example system clock, communication channels, input and output pins;
integrated and optional peripheral control driver involved in sensor management;
driver for controlling peripherals communicating with the outside world, for example WIFI.

The second relevant software component is called “application software” and consists of the portion of the program which, by directly controlling the basic software, performs predefined operations. Also, in this case the application software is created and preloaded in the production phase and cannot be modified by the user. The application software has two fundamental characteristics:
it can perform one or more operations between the predefined and preloaded ones or it can also remain in standby mode without performing any of them;
the way in which the operations are performed depends on the values written in a portion of non-volatile memory: these values are the “configuration parameters”. The latter correspond to the previously mentioned parameters that can be set by the user.

Therefore, the third relevant software component is given by the configuration or settable parameters: these are advantageously numerical or textual values stored in a non-volatile memory portion and are the only software portion that can be modified by the user. A particularly relevant detail is that the configuration parameters are in fact pure numerical or textual values, not of the operating codes, therefore they influence the behaviour of already programmed operations. This means, for example, that a software routine cannot be identified as a settable parameter.

From an application point of view, the possibility of creating only the configuration with system 1 can be achieved by a configurator.

The configurator can be, for example, a program that does not reside in the electronic system 1 described but can be run on a PC, smartphone or tablet of the user. This program allows you to:
communicate with the system 1 described;
read the manipulable or configuration parameters present in the dedicated memory of system 1;
present to the user the status of the system 1 and its parameters;
allow the user to modify one or more configuration parameters;
check the consistency of the configuration parameters;
transmit the new configuration parameters to the electronic system and order their replacement instead of the previous ones in the dedicated memory.

The configurator is therefore preferably the tool with which the user interacts with system 1. It advantageously constitutes a big difference with normal programmable electronic systems, in which the user has access to particular tools that allow to write code, to compile it for generating the machine language and loading the new machine code in place of the previous one. Configurable only system 1 does not allow the user to modify and overwrite the pre-existing program: the user can only define a set of modifiable parameters (i.e. typically numeric or textual values, not executable code) and transmit them to system 1 which interprets them the meaning and act accordingly by activating some operations with certain characteristics (frequency, communication or other).

Another feature of the configuration tool consists in the need to use it only in a first phase, called “configuration”, when the user makes his choices and transmits them to system 1. Once the transmission to system 1 has been carried out, the Manipulated parameters are stored in the special non-volatile memory and the configurator can be disconnected. At each subsequent restart of the system 1, the application software preferably copies the parameters defined by the user into the volatile memory and carries out operations in accordance with the choices made by the user during the configuration phase.

The functional means 25 can therefore be of various kinds.

For example, the functional means 25 may comprise a sensor 250.

The sensor 250 can be any active or passive device capable of detecting, for example, at least one quantity and of forwarding it to the processor 21 to compare it with a pre-set value determined by the parameter.

The functional means 25 can include one or more sensors 250 to be chosen from light sensor, gas sensor, motion sensor, atmospheric pressure sensor, temperature sensor, humidity sensor, distance sensor, angular position sensor, proximity, geolocation, compass or more.

Of course, the function can be modified both in the sense of modality and in the sense of quality. The parameter can allow you to change the nature of module 2, for example by passing through a temperature sensor and a pressure sensor, or alternatively or in addition, the parameter can allow you to change the threshold values detected by the sensors, for example by changing the distance for a proximity sensor or by modifying the operating period by making the sensor 250 always active, periodically active or temporarily active.

Naturally, the variants described above referring to the parameters apply equally to the other functional means 25 described below.

In fact, the functional means 25 can include one or more commands 251.

The commands 251 can be elements able to allow the module 2 to be controlled. Furthermore, it can also be able to allow to determine input data to the processor 21. Therefore, if the functional means 25 are provided with commands 251, the manipulation of the parameter, or of the parameters, can be performed directly through the functional means 25.

The commands 251 as just described can be a button, a keyboard, an analogue input with slider, a rotary digital input or similar.

Of course, the controls 251 are preferably at least partially arranged on the container 4 in such a way as to be accessible. They can therefore be arranged on the side walls 41 or also on the flat walls 40.

The functional means 25 can also include a power supply device 252.

If present, the power supply device 252 is substantially a device suitable for self-powering the same module 2 or powering one or more other modules 2. Therefore, at least one module 2 can be simply configured to power the other modules 2 by determining this function.

Naturally, the power supply device 252 can substantially be of the same type, or coincide, with the first interface means 2, in particular the wiring 221 and the wireless connector 222.

Or, the power supply device 252, when intended to self-power the module 2, replaces the power supply means 24. In other words, the power supply device 252 can realize the power supply means 24.

The functional means 25 can also include, in addition, one or more actuators 253. The actuators 253 are substantially functional means 25 whose operation involves the generation of an external physical output, for example a light signal, a message, a push or the like.

The actuators 253 are therefore configured to carry out at least one predetermined action established on the basis of at least one parameter.

Such actuators 253 can be a microphone, a speaker, a buzzer, a GSM or email communication module, a webcam, a relay controller, a DC motor controller, a stepper motor controller, a servo motor controller, a LED controller, un display or even more.

At least part of the actuators 253 is therefore preferably accessible from the outside and included in the container 4, for example arranged on the flat walls 40 or on the side walls 41.

Or, one or more walls 40, 41 can be transparent in such a way as to allow any light signals or a screen integrated in the container 4 to be viewed from the outside.

In conclusion, the system 1 can include at least one auxiliary connector 26. In particular, the auxiliary connector 26 is preferably included in the common portion 2a.

If present, the auxiliary connector 26 is configured to operatively connect said processor 21 additional functional means 25. This means that the auxiliary connector 26 can allow to add further functions to a module 2 already equipped with its own singular portion 2b. Alternatively, the module 2 can be provided with only the common part 2a and with an auxiliary connector 26 configured to allow the connection of a singular portion 2b, or of the functional means 25, to the common portion 2a, in particular to the processor 21.

In each preferably, the auxiliary connector 26 allows to expand the functions of the module 2 possibly introducing further sensors 250 and/or commands 251 and/or power supply devices 252 and/or actuators 253.

The operation of the modular play-educational system 1 previously described in structural terms it is the following.

When system 1 is started up, the application software proceeds with the initialization of the hardware components to be used, making use of the “API” provided by the basic software. In this phase, the manipulatable or configuration parameters present in the non-volatile memory are read and copied into the volatile memory (RAM). Subsequently, the application software code performs or does not perform the various predefined operations depending on the value of some configuration parameters created specifically for this type of control. For example, system 1 with an integrated temperature sensor and an external port for connecting a second temperature sensor may or may not perform a reading of the integrated sensor depending on a parameter responsible for activating or deactivating this operation: the parameter can be a memory bit such that 1=reads, 0=does not read. Similarly, the system 1 may or may not perform the same operation on the other optional sensor, depending on a second parameter of the same nature. Therefore, in a system described in this way, there are two boolean configuration parameters “EnableSensor1” and “EnableSensor2”. In the example cited it is also possible to have parameters that determine the reading frequency of the sensors: the “FrequencySensor1” and “FrequencySensor2” parameters which can be integer values between 1 and 255 in which 1 corresponds to a reading of the relative sensor every second while 255 a sensor reading every 255 seconds. It is also possible to introduce a fifth “DestinationIP” parameter consisting of four values between 0 and 255 corresponding to the IP address to which a message is sent with a predefined format containing the temperature values read.

The definition of the aforementioned manipulatable or configuration parameters above can be made by the user. As can be seen, therefore, the user has a very limited number of operable choices: the combinations of parameters are extremely lower than the possibilities that a programmer would have in writing a system control software 1. This feature, as previously described, limits the vastness of the choices that can be made and therefore reduces the complexity of system 1, severely limiting it to perform operations that are most likely those that the user expects, or rather that a system with two temperature sensors simply has to read the temperature and communicate it.

In the example, the effect obtained by simply defining the above five parameters is completely equivalent to a digital electronic system programmed to perform the same function, with the difference that in this case the programming is not carried out by the user but preloaded in the production phase and left free to operate on the basis of only the five editable parameters defined by the user. The configuration therefore hides the complexity.

In a further example of embodiment in which the system 1 is to be configured to remotely turn on a LED when the user approaches a sensor, the modules 2 can be configured as described below.

Once two modules 2 are found, they are mutually spaced apart and the first and/or second interface means 22, 23 connect the modules 2. The first module 2 can simply be composed of functional means 25 including a battery-powered power supply device 252 and a sensor 250 in particular in proximity. The second module 2 can be composed of functional means 25 including a power supply device 252, with photovoltaic modules, and an actuator 253 comprising a controller of a LED visible for example through a transparent wall 40, 41. The programs in the processors 21 of the modules 2 are, of course, pre-programmed and therefore ready to be executed.

The modules 2 initially remain inactive because they lack the functional information necessary for operation, that is, the parameterization necessary for configuration. The external user can therefore define the configuration of the modules by manipulating or setting the configuration parameter or the operating parameters of the functional means 25.

The manipulation can take place, for example, by means of a device 3 including a smartphone equipped with a suitable application.

The user can set the generation of an event, in the form of output data, when the measured distance is below a certain threshold. The configuration parameters used can therefore be a threshold value, for example 1 m, and a type of threshold, for example sub-threshold. The generated event is assigned an identifier, for example a name such as “alarm”. The user then proceeds with the configuration of the LED management module and sets the action of switching on the LED upon receipt of an event, that is to say of an input data. The configuration parameters used are therefore the status of the LED, for example on, and an input data, consisting in this case of a correlated event, for example the occurrence of the “alarm” event. Furthermore, also the power supply devices 252 are finally configured to constantly supply energy to the respective module 2. The configuration parameter used on both is an activation time parameter which implies constant activity, or rather always active.

Naturally, the power supply devices 252, especially in this case, could be replaceable with power supply means 24 possibly operable by means of an actuator 253 including a power supply controller and a command 251 such as an ignition button.

Once the configuration has been completed, the parameter is stored in the storage medium 20 and used during the execution of the computer program. The system 1 begins to operate according to the user's expectations without any programming of the program, but simply by defining the operation of the system 1 by describing its functional behaviour through the configuration parameters.

The invention also includes a new method of implementation of the system 1.

In fact, although there are procedures for the functionalization of systems, no procedure in the field of play envisages pre-programming the computer program and configuring the computer 21 to allow only manipulation by means of the device 3 or the functional means 25 of at least one parameter to the external user in such a way as to allow only the configuration of the function without modifying the programming of the program.

Furthermore, the new method may comprise a coupling phase in which the modules 2 are coupled. For example, this phase can be carried out by the first interface means 22, in particular by means of the magnetic elements 220, by stacking the modules 2 one on top of the other.

Furthermore, the method can include a connection phase between the modules 2, in which the modules 2 are mutually connected through the first interface means 22, for example the wiring 221 or the wireless connectors 222, or through the second interface means 23.

These phases, if present, are subsequent to the pre-programming of the program for computer and in the computer configuration 21.

Following the above-mentioned phases, in conclusion, the method preferably includes a manipulation phase in which at least one parameter is manipulated, or set, in such a way as to establish the function performed by the functional means 25.

The ludic-modular system 1 according to the invention achieves important advantages.

In fact, the ludic-educational modular system 1 is able to reduce management complexity while maintaining high functional performance.

In fact, unlike the systems commonly present on the market today which provide for use through mere programming, the pre-programming of the modules 2 of the system 1 limits the functions accessible by the user to the functions made available for configuration only. The programming therefore serves to make the technical characteristics of the electronics of the modules 2 accessible and available for the configuration phase. The programming of modules 2 is normally precluded to the user. The functionalities are ready for use but their implementation and their harmonization are obtained from the configuration, which corresponds to a set of parameters, variable from module 2 to module 2 according to the functional means used.

Another advantage of the system 1 is given by the fact that the modules 2 are substantially adaptable to any situation and to perform completely different and, if desired, complementary functions.

The singular portion 2b ensures this characteristic, but does not burden the system 1 whose modules 2 in any case make use of a predominant common portion 2a. The system 1 is also well suited for simple use by non-expert users, for example of a young age, for playing games or for learning the basics in managing interactions and the connection between electronic devices.

Basically, the system 1 allows the user to concentrate on the action to be taken, that is, on what to do, rather than on the methods of carrying out the action, or on how to do it.

Furthermore, the system 1 is also easily adaptable to other sectors such as that of home automation, robotics and other sectors that still make use of the use of electronic devices.

The invention is susceptible of variants falling within the scope of the inventive concept defined by the claims.

In this context, all the details can be replaced by equivalent elements and the materials, shapes and dimensions can be any.

1. A ludic-educational modular system comprising a plurality of electronic modules,
wherein said electronic modules each comprise
a common portion to all modules including
an equivalent storage medium configured to include at least one computer program,
an equivalent computer operatively connected to said storage medium and configured to process input data and return output data based on said program,
equivalent first interface means configured to operatively connect said modules to each other,
equivalent second interface means configured to operatively connect said module reciprocally to at least one external electronic device or another said module and to transmit said input data and said output data between said module to at least one device or another said module or,
a singular portion including
functional means operatively connected to said processor and configured to perform at least one predetermined function by generating said output data on the basis of at least one parameter that can be set in said program for computer,
and
said computer program is pre-programmed, and
said computer is configured to allow only the manipulation, through said functional means and/or said device, of said at least one parameter to an external user in such a way as to allow only the configuration of said function without modifying the programming of said program.

2. The system according to claim 1, wherein said first interface means include one or more choice between magnetic elements adapted to reciprocally constrain said modules, electrical wiring and wireless connectors configured to put said modules in direct communication and to transmit said input data and said output data between said modules.

3. The system according to claim 1, wherein said second interface means comprise at least one wireless device configured to put in communication said module with said device and/or another said module.

4. The system according to claim 1, wherein said functional means comprise one or more chosen from a sensor configured to detect at least one quantity of state of an external environment, a command configured to allow direct interaction between said module and said external user, a power supply device configured to self-power said module or power at least one other said module and an actuator configured to carry out at least one predetermined action established on the basis of said at least one parameter.

5. The system according to claim 1, wherein the common portion comprises equivalent power supply means configured to feed at least said processor.

6. The system according to claim 1, wherein each of said modules is included in a container defining the shape of a plate including at least two flat walls opposite each other, configured to allow stacking said modules in a stable manner and including said first interface means.

7. The system according to claim 6, wherein said common portion comprises at least one auxiliary connector configured to operatively connect said computer and said functional means or said computer and further other said functional means in such a way as to allow to expand the functions of said module.

8. The system according to claim 1, wherein said power supply means comprise a power supply connector configured to allow an electrical connection between said module and an external power supply and said container comprises side walls comprising one or more chosen between said first interface means and said power supply connector.

9. A process of making a system according to claim 1 comprising:
pre-programming said computer program, and
configuring said computer to allow only manipulation by means of said device and/or said functional means of said at least one parameter to said external user in such a way as to allow only the configuration of said function without modifying the programming of said program.

10. The process according to claim 9, comprising:
mutually coupling at least two modules through said first interface means,
operatively connecting said modules through said first interface means or said second means interface,
manipulating at least one said parameter in such a way as to establish a said function performed by said functional means.

11. The system according to claim 2, wherein said second interface means comprise at least one wireless device configured to put in communication said module with said device and/or another said module.

12. The system according to claim 11, wherein said functional means comprise one or more chosen from a sensor configured to detect at least one quantity of state of an external environment, a command configured to allow direct interaction between said module and said external user, a power supply device configured to self-power said module or power at least one other said module and an actuator configured to carry out at least one predetermined action established on the basis of said at least one parameter.

13. The system according to claim 12, wherein the common portion comprises equivalent power supply means configured to feed at least said processor.
